(19) United States
(12) Patent Application Publication
(10) Pub. No.: US 2004/0120648 A1
(43) Pub. Date: Jun. 24, 2004

(54) Spot size converter and method for manufacturing the same, and spot size converter integrated photodetector

(76) Inventors: Yong Hwan Kwon, Daejon-Shi (KR); Joong Seon Choe, Seoul (KR); Ki Soo Kim, Jeonju-Shi (KR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/729,482

(22) Filed: Dec. 4, 2003

(30) Foreign Application Priority Data
Dec. 16, 2002 (KR) 2002-80112

(51) Int. Cl. G02B 6/26

(52) U.S. Cl. 385/43

(57) ABSTRACT

Disclosed herein are a SSC integrated optical device and a method of manufacturing the same. When a taper waveguide in a SSC region is formed, a width and a thickness are controlled exactly by means of a selective wet etch method. In particular, a start portion of the taper waveguide is formed to have a mesa structure or a reverse-mesa structure. Accordingly, it is possible to control process parameters reproducibly, reduce the cost for an optical alignment and improve an optical coupling efficiency and quantum efficiency remarkably.

### BACKGROUND OF THE INVENTION

1. Field of the Invention

The present invention relates to a spot size converter (SSC) and a method of manufacturing the same, and a spot size converter integrated photodetector, wherein an incident light emitted from an optical fiber is easily coupled to an optical device, thus reducing the cost for an optical alignment and improving an optical coupling efficiency.

2. Background of the Related Art

A photodetector among optical devices on which a spot size converter (SSC) can be integrated will be described as an example.

The structure of a semiconductor photodetector used for an optical communication can be classified into a planar incidence structure (or normal incidence structure) and a waveguide structure (or edge incidence structure) depending on an optical incidence scheme. It is known that the planar incidence structure is relatively useful in an optical coupling and a manufacturing process and the waveguide structure is relatively useful in the value of the product of a bandwidth and a quantum efficiency. For this reason, the planar incidence structure, which is profitable in optical coupling, is mostly used in operating speed regions of below 10 Gbps class. The photodetector chip having the planar incidence structure of 10 Gbps class has a chip diameter in the range of approximately 20 μm to 30 μm. Accordingly, the photodetector chip has a high optical coupling efficiency with a single mode optical fiber having a mode spot size of about 10 μm.

On the contrary, it is reported that the bandwidth times a quantum efficiency makes about ˜20 GHz, in the planar incidence structure. Therefore, in a chip structure for use in a 40 Gbps class optical receiver, the planar incidence type structure and the waveguide type structure are competing. In the waveguide type structure, when operating 40 Gbps, it is possible to make the value of the product of a bandwidth times a quantum efficiecy higher than 20 GHz by lengthening an effective absorption length. At this time, the quantum efficiency is mostly restricted by the coupling efficiency between the optical fiber and a photodetector. The waveguide structure will be advantageous compared to the planar incidence structure when the quantum efficiency of the waveguide structure is more than 50%. A common waveguide type photodetector, however, has a high coupling loss when the incident light is coupled. The reason is that the optical modes of the optical fiber and the photodetector show a large mismatch in size. In particular, although the spot size in a normal direction of the photodetector is varied in structure, it is about ˜1 μm. Accordingly, the coupling efficiency with the single mode optical fiber is less than 10%.

In order to solve these problems, research has been actively made into the SSC structure coupled to the photodetector to increase the spot size on the side to which light is incident, in which the spot shape is converted to be circular, whereby it is easily optically coupled with the single mode optical fiber or a lensed optical fiber. A direct optical coupling without additional optical system, a low optical coupling loss, a high optical alignment tolerance, etc. can be obtained between the optical fiber and the photodetector by using the SSC structure.

Parameters to be considered in designing the SSC integrated photodetector structure are as follows. For the high optical coupling efficiency with the optical fiber, the spot size of the waveguide mode on the light incidence plane' side must be well coincident with the spot size of the optical fiber in a circular shape. The subsequent region serves to convert a relatively large spot size adiabatically into a small one without a radiation loss of light. The waveguide mode of which the spot size is converted as above is absorbed into the absorption layer through a refractive index matched waveguide or an evanescent coupling of the modes.

Hereinafter, some representative structures among various SSC structures proposed above will be explained. Although there are various structures presented like this, a structure having two waveguides formed in the SSC region has advantages that it has a simple manufacture process and is thus suitable for mass production, since the waveguides can be optimized and photo-lithographed without using an e-beam lithography method, wherein one of the two waveguides is manufactured to have a large mode spot size for the optical coupling with the optical fiber and the other is gradually tapered in size for the efficient transfer of light into the absorption layer.

A conventional SSC integrated photodetector will be below described in detail with reference to FIG. 1.

Referring to FIG. 1, a SSC integrated photodetector has a structure in which two waveguides 13 and 14 are formed in a SSC region of an InP substrate 11, wherein one waveguide 13 is used for an optical coupling with a optical fiber and the other waveguide 14 is gradually tapered in thickness in order to convert the spot size adiabatically.

In other words, the taper waveguide 13 in a vertical direction on an upper side must have a thickness in the range of 1 μm in a taper start portion and a taper length in the range of 500 μm to 1000 μm, so that said taper waveguide 13 pulls up a light adiabatically, said light goes through the waveguide on a lower side. In order to form this vertical taper waveguide 13, a new photolithography method improved compared to the existing photolithography method has been presented. This enables a fixed mask in the conventional photolithography process equipment to move, thereby reducing the amount of exposed light around the edge of the opened portion in the mask. By means of this method, at first, the taper waveguide in the vertical direction is formed in the photoresist, and then, the vertical taper waveguide is transferred to the sample surface by using an ion beam etching method.

In the following, another conventional SSC integrated photodetector will be described in detail with reference to FIG. 2. The SSC integrated photodetector has a structure in which three waveguides are formed in the SSC region, wherein one waveguide is used for the optical coupling with the optical fiber and the rest are gradually tapered in width in order to convert the spot size adiabatically. A conceptual view of this structure is shown in FIG. 2. At this time, the first taper waveguide 23, which becomes an InGaAsP (λg=1.05 μm) single mode waveguide of 500 μm in length, serves to pull up the light adiabatically, said light goes through the lower waveguide. The second taper waveguide 24, which becomes an InGaAsP (λg=1.4 μm) multi-mode waveguide of 250 μm in length, serves as a refractive index matching layer between the first taper waveguide 23 and an absorption layer 25, so that the light existing in the first taper waveguide is well absorbed into the absorption layer.

In this case, the start portions of the first and second taper waveguides 23 and 24 must have tip widths of 1 and 0.5 μm, respectively. They are fabricated by the reactive ion etch (RIE) method of the dry etching method.

Problems that the structure and fabrication process in these conventional technologies may affect device performance can be summarized as follows.

First, the taper structure in which a thickness in the vertical direction is tapered, as shown in FIG. 1, requires complicated processes such as a selective MOVPE method or a new method improved compared to the existing photolithography method, or new technology.

On the other hand, the taper structure in which the width in the horizontal direction is tapered, as shown in FIG. 2, has advantages that it can be fabricated by using one epitaxial growth and employ the existing photolithography method. However, this taper structure also has the following problems.

First, it is preferred that the start portion of the taper waveguide fabricated by the photo-lithography and RIE method has a width of 1 μm by maximum. As shown in FIG. 2, when calculated by using beam propagation method (BPM), if the widths of the start portions are extended to 1.2 and 1.4 μm, the optical absorption coefficients are lowered to 70% and 30%, respectively, in case of a device having the absorption layer of 4 μm in width and 30 μm in length. In other words, the start portion of the taper waveguide becomes a very important factor. However, those skilled in the art will appreciate that a numerical value of this start portion is the limited value in the implementation and reproduction when the photolithography method is used. Furthermore, the taper waveguide is formed immediately on a irregular plane in which the waveguide mesa for the optical absorption is formed, not a flat plane. Thus, it is more difficult to satisfy these dimensions.

Second, the thickness of the taper waveguide is implemented by using the RIE method only. The thickness of the taper waveguide in FIG. 2 is in the range of 0.5 μm to 0.7 μm. At this time, it is required to exactly control the thickness during the RIE. In case of FIG. 2, it is noted that the optical absorption coefficients against thickness tolerances are dropped to ˜90% in case of ±0.05 μm and ˜80% in case of ±0.1 μm. Accordingly, in order to overcome those problems and manufacture the SSC integrated photodetector that is economic and has good characteristics, there is a need for a new structure and a new process method, in which important process parameters such as the width and thickness of the start portion of the taper waveguide can be suitably controlled, while optimizing characteristics of the SSC region.

### SUMMARY OF THE INVENTION

Accordingly, the present invention is contrived to substantially obviate one or more problems due to limitations and disadvantages of the related art, and an object of the present invention is to control and reproduce important process parameters such as a width and a thickness of a start portion of a taper waveguide in a SSC region.

The present invention is directed to provide a method of exactly controlling a width and a thickness of a taper waveguide by means of the selective wet etch process when the waveguide of the SSC region is formed.

Further, the present invention is to provide a structure that has good characteristics and can be easily fabricated by optimizing a function of converting a spot size gradually, which is applied to an original object of the SSC, and method thereof.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

One aspect of the present invention is to provide a spot size converter, comprising: a semiconductor substrate; a first waveguide stacked on the semiconductor substrate in a ridge shape and provided for optical coupling with an optical fiber; and a second waveguide formed on the first waveguide for a spot size conversion, wherein the second waveguide has a taper shape having a width that is gradually widened in a direction along the waveguide from a start portion, and the start portion of the second waveguide has a mesa structure or a reverse-mesa structure.

The mesa structure or the reverse-mesa structure has a width of below 1 μm (middle portion in thickness).

In addition, the first waveguide consists of a multi-layer, and the multi-layer has a structure such three InP layers of 600 nm in thickness and three InGaAsP (λg=1.24 μm) layers of 50 nm in thickness are stacked alternately and repeatedly; and the second waveguide has an InGaAsP (lg=1.24 μm) layer in the range of 500 nm to 600 nm in thickness.

One aspect of the present invention is to provide a method of manufacturing a spot size converter, wherein the spot size converter includes a semiconductor substrate; a first waveguide stacked on the semiconductor substrate in a ridge shape and provided for optical coupling with an optical fiber; and a second waveguide formed on the first waveguide for a spot size conversion, wherein the second waveguide has a taper shape having a width that is gradually widened in a direction along the waveguide at a start portion, characterized in comprising the steps of: forming an etch mask on the second waveguide to remain the taper shape; performing a dry etch of a given depth for the second waveguide using the etch mask; and

forming the start portion of the second waveguide dry etched, to have a mesa structure or a reverse-mesa structure by using an undercut wet etch process.

The etch mask has a width in the range of 1.5 to 2 μm and is formed by photolithography, and the mesa structure or the reverse-mesa structure has a width of below 1 μm (middle portion in thickness).

In addition, the second waveguide has an InGaAsP (lg=1.24 μm) layer in the range of 500 nm to 600 nm in thickness; the dry etch process etches the second waveguide in thickness in the range of 200˜400 nm; and the undercut wet etch process is implemented by using a phosphoric acid based etch solution.

The mesa structure or the reverse-mesa structure has a azimuthal angle in the range of 30° to 60°.

Further, one aspect of the present invention is to provide a spot size converter integrated photodetector, comprising: a semiconductor substrate; a first waveguide for optical coupling with an optical fiber that is stacked on the semiconductor substrate and divided into a photodetection region and a spot size converter region, wherein the first waveguide is patterned in the spot size converter region in a ridge shape; a second waveguide for converting the spot size; wherein the second waveguide has a taper shape having a width that is gradually widened in a direction along the waveguide from a start portion on the first waveguide of the spot size converter and start portion of said second waveguide of the spot size converter has a mesa structure or a reverse-mesa structure, and said second waveguide is extended to the first waveguide of the spot size converter on the photodetection region; and an absorption layer, a cladding layer and an electrode layer, which are consecutively formed on the second waveguide of the photodetection region.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a constitutional view of a conventional SSC integrated photodetector,

FIG. 2 is a constitutional view of another conventional SSC integrated photodetector,

FIG. 3 is a constitutional view of a SSC integrated photodetector according to a preferred embodiment of the present invention,

FIG. 4A is a cross-sectional view of the SSC integrated photodetector shown in FIG. 3,

FIG. 4B is a graph showing the refractive index of each layer,

FIG. 5A and FIG. 5B are conceptual views showing mode distribution at the start and end portions of the taper waveguide,

FIG. 6A and FIG. 6B are SEM photographs each showing examples in which the start portion of the waveguide in the SSC integrated photodetector shown in FIG. 3 is formed to have a mesa structure and a reverse-mesa structure,

FIG. 7A and FIG. 7B are graphs each showing the effective absorption coefficient and quantum efficiency depending on variation in the width of the start portion that were computer-simulated by the BPM when the start portion of the taper waveguide in FIG. 3 is formed to have the normal shape, the mesa shape and the reverse-mesa shape, and

FIGS. 8 to 14 are cross-sectional views of the SSC integrated photodetectors for explaining a method of manufacturing the photodetector according to a preferred embodiment of the present invention.

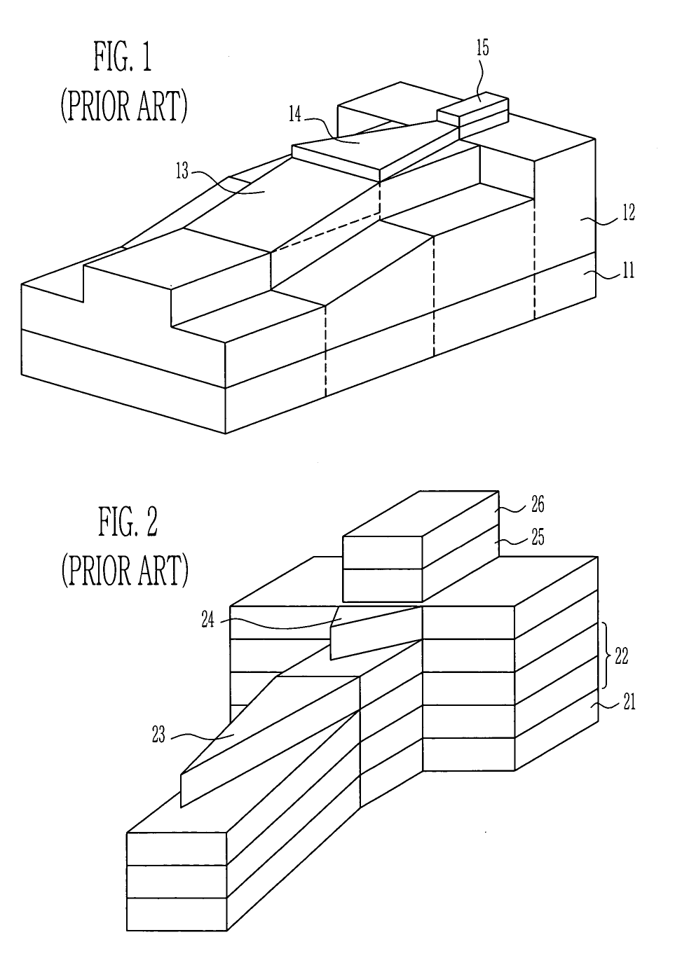

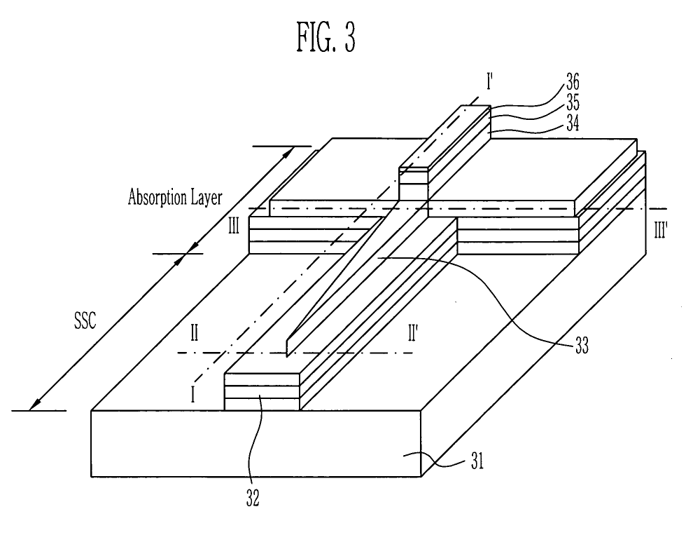

### DETAILED DESCRIPTION OF THE PREFERRED EMBODIMENTS

Reference will now be made in detail to the preferred embodiments of the present invention, examples of which are illustrated in the accompanying drawings. In the present invention, it is to be understood that both the foregoing general description and the following detailed description of the present invention are exemplary and explanatory and are intended to provide further explanation of the invention as claimed.

Meanwhile, in the following embodiments, a ridge-shaped SSC integrated photodetector will be described as an example. However, it should be noted that an optical device that can be coupled to the SSC waveguide is not limited thereto but various optical devices having a waveguide structure can be coupled to the SSC waveguide. Examples of the optical devices having the waveguide structure may include a semiconductor optical amplifier, an optical modulator, and the like.

As shown in FIG. 3, the SSC integrated photodetector has two regions that are an absorption region and a SCC region. The SSC region has a waveguide (hereinafter called “first waveguide”) 32 and a taper waveguide (hereinafter called “second waveguide”) 33. The first waveguide 32 for the optical coupling with the optical fiber is fabricated to have a circular shaped mode spot in accordance with the spot size of the optical fiber to optimize an optical coupling efficiency. In the absorption region, an undoped InGaAs absorption layer 34, a P type InP cladding layer 35 and a P+ InGaAs contact layer 36 are grown on the structure in which the second waveguide 33 of the SSC region is extended, thus completing an entire waveguide structure.

The start portion of the second waveguide 33 has a value of below 1-μm-width. The width of the start portion of the second waveguide 33 is gradually increased to have a value of about ˜3 μm at the front end of the absorption layer. Thus, propagating lights within the waveguide for the optical coupling with the optical fiber are pulled up adiabatically and mostly confined in the taper waveguide. The resulting Light confined as above is absorbed into the absorption layer 34 through evanescent coupling. At this time, the taper waveguide is contiguous with the absorption layer 34, so that efficient absorption can be accomplished.

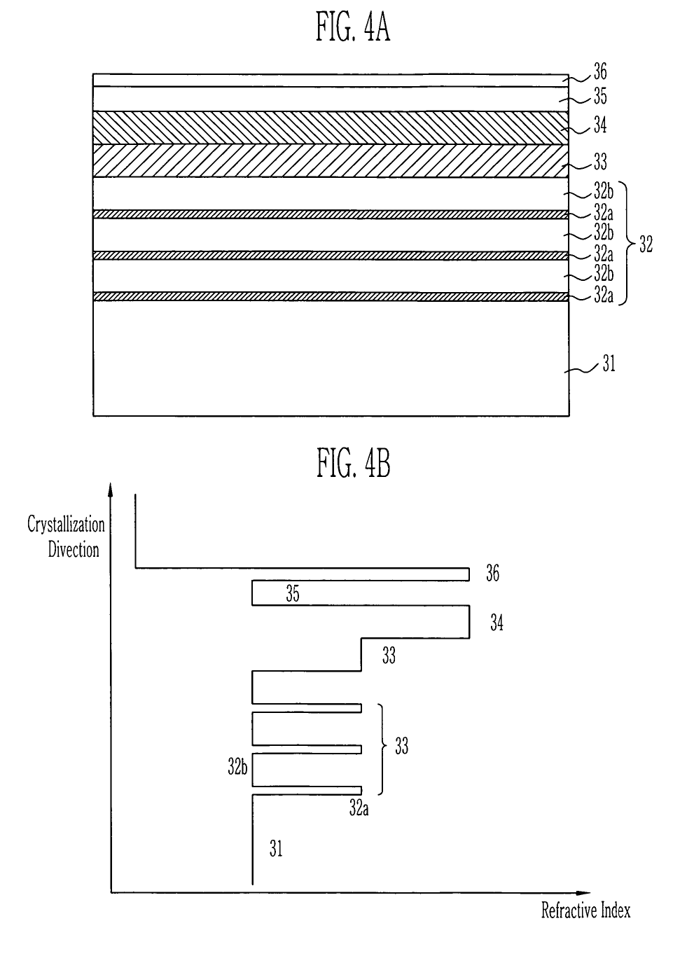

In order to fully understand the operational principle of the present invention, the structure of the epitaxial layer in the fabricated device will be explained. FIG. 4A is a cross-sectional view of the epitaxial layer for manufacturing the SSC integrated photodetector shown in FIG. 3 and FIG. 4B is a graph showing the refractive index of each of the layers.

The cross-sectional view of the epitaxial layer in FIG. 4A corresponds to the absorption region among the cross-sectional views taken along lines I-I′ in FIG. 3. As shown in FIG. 4A, the first waveguide 32 for the optical coupling with the optical fiber is grown on the InP substrate 31 and has a ridge-shaped multi-layer. The multi-layers 32a and 32b consist of three InP layers 32a of about 600 nm and three InGaAsP (λg=1.24 μm) layers 32b of about 50 nm, which are stacked alternately and repeatedly. The second waveguide 33 formed on the first waveguide 32 has an InGaAsP (lg=1.24 μm) layer in the range of 500 nm to 600 nm in thickness. This layer 33 serves to convert the size of the mode spot and is doped with an N type dopant since it is used as the N contact layer

The InGaAsP materials used for the first waveguide 32 and the second waveguide 33 have the same composition. This may be helpful not only in growing epitaxial layer in accordance with a designed structure since it can reduce one of important growth parameters, but also in the feedback of the epitaxial growth through the analysis results. However, those skilled in the art will appreciate that the InGaAsP materials may be grown using different materials.

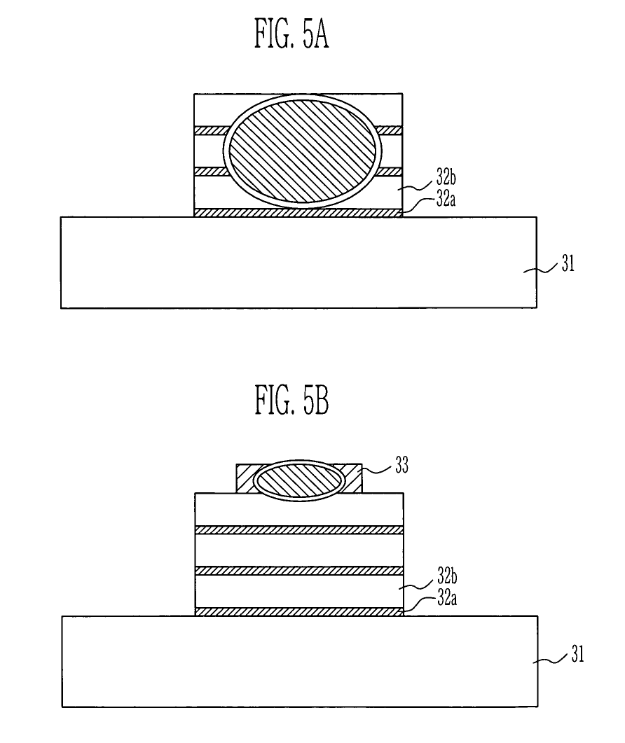

Distribution of the refractive index will be described with reference to FIG. 4B. The first waveguide 32 having a low effective refractive index is formed on a lower side and the second waveguide 33 having a high refractive index is formed on the first waveguide 32. FIG. 5A and FIG. 5B illustrate a cross-sectional view of the waveguide structure and spot distribution at the start portion of the first waveguide 32 and the end portion of the second waveguide 33. FIG. 5A is the cross-sectional view of the waveguide structure taken along lines II-II′ in the SSC integrated photodetector of FIG. 3, and FIG. 5B is the cross-sectional view of the waveguide structure taken along lines III-III′ in the SSC integrated photodetector of FIG. 3.

In the region where the second waveguide 33 is finished, the two waveguides 32 and 33 exist at the same time. In this case, the spot distribution is decided by the waveguide 33 having a relatively high refractive index. An important fact in this structure is that the spot of FIG. 5A has to be converted adiabatically without a radiation loss of light to a spot shape of FIG. 5B. For this purpose, it is preferred that the width of the start portion in the taper waveguide 33 is kept below 1 μm.

For this, the start portion of the second waveguide 33 is formed to have a mesa structure or a reverse-mesa structure. In other words, in performing the etch process for forming the second waveguide 33, a dry etch process is performed to a given depth and a selective wet etch process is then implemented to control the thickness of the second waveguide 33 exactly. At the same time, the width of the start portion is formed to have the mesa structure or the reverse-mesa structure of below 1 μm through the undercut etch process.

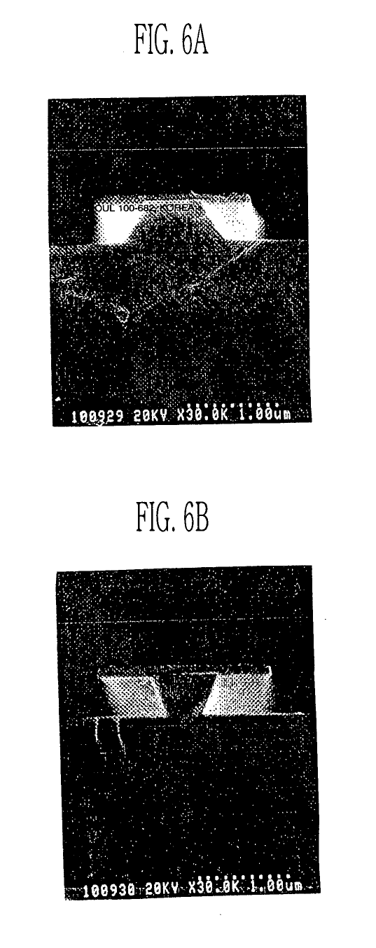

An advantage of this structure is that a waveguide pattern requiring fine control of below 1 μm can be easily formed using a pattern having a width in the range of 1.5 μm to 2 μm formed in a silicon nitride film. In other words, the pattern having the width in the range of 1.5 μm to 2 μm can be formed sufficiently through the conventional photo-lithography. Therefore, it is possible to simplify the manufacturing process. For example, scanning electron microscopy (SEM) photographs of the waveguides, in which InGaAsP of 500 nm in thickness is used as the second waveguide 33 and for which an undercut etch is performed using a phosphoric acid based etch solution after the dry etch in the range of 200 nm to 400 nm, are shown in FIG. 6A and FIG. 6B.

FIG. 6A and FIG. 6B are cross-sectional views of the waveguides, in which the directions of the waveguides are positioned in planes [11-0] and [110], respectively. This etch solution operates not in a diffusion-limit region but a reaction-limit region. Thus, the etch solution is formed with a tendency to expose a (111) plane. As shown in FIG. 6A and FIG. 6B, as undercut is about 500 nm, lower and upper parts of the mesa structure at the start portion of the waveguide 33 can have the widths of ˜0.5 and 1 μm, respectively, using the silicon nitride film pattern having the width of 1.5 μm in case of FIG. 6A. Meanwhile, the azimuthal angle of the waveguide remaining in the mesa structure or the reverse-mesa structure may be changed by controlling the etch solution, etc., which may be 30˜60°.

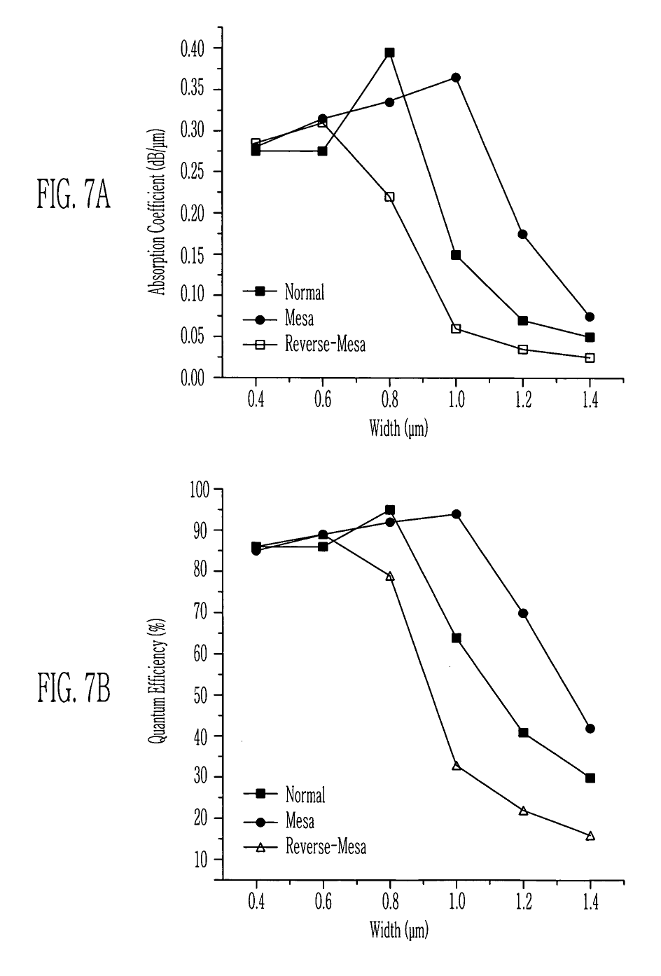

In case that the start portion of the second waveguide 33 is the mesa structure or the reverse-mesa structure, computer simulation was implemented for each of them. FIG. 7A and FIG. 7B are graphs showing the results of computer-simulating the effective absorption coefficient and quantum efficiency depending on variation of the width in the start portion by means of a BPM, when the cross section of the start portion of the second waveguide 33 has the normal structure, the mesa structure and the reverse-mesa structure. At this time, the width at the middle portion of the second waveguide 33 is set as a parameter. Also, the second waveguide 33 region is divided into two regions, wherein the length of the region having a width extended from 1.0 μm to 2.0 μm is set to 400 μm and the length of the region having a width extended from 2.0 μm to 3.0 μm is 100 μm. Based on the widths, the widths of the mesa type structure and the reverse-mesa type structure are generally changed by the width of the start portion. Quantum efficiency is calculated in case of a device having an absorption layer of 4 μm in width and 30 μm in length. At this time, it was assumed that coupling efficiency of light between the optical fiber and the first waveguide is 100%. However, considering the coupling loss, the practical value will be lower than the calculated value.

As shown in FIG. 7A, it can be seen that the waveguide 33 having the start portion of the mesa structure has the similar absorption coefficient and the smooth inclination of variation in quantum efficiency against variation in the width, compared to the conventional normal structure, when calculating by the BPM. That is, the waveguide 33 has a high tolerance of a process error. In other words, the mesa structure has an advantage that it can be formed to have a width of below 1.0 μm. It can be seen that the absorption coefficient of the mesa structure is excellent compared with a case, where the normal structure has a width of over 1.0 μm. Likewise, the reverse-mesa structure is not significantly different in the absorption coefficient from the normal structure. Particularly, in case of comparing the normal structure having 1.0 μm with the reverse-mesa structure having 0.8 μm, it is noted that the absorption coefficient of the reverse-mesa structure is better. This can be fully understood, taking into considerations that the normal structure of below 1.0 μm is difficult to fabricate but the reverse-mesa structure of below 1.0 μm can be easily fabricated. Furthermore, from FIG. 7B, it can be seen that the mesa structure and the reverse-mesa structure are more useful than the normal structure even in quantum efficiency.

Particularly, in case of the mesa structure, there is no significant difference in quantum efficiency even though the undercut etch process is excessively made along the waveguide compared to a target value. This means that the margin of the process error can be secured more (see FIG. 7A and FIG. 7B).

Meanwhile, undercut etch time taken to implement a desired width can be decided after confirming the size in the width of the pattern formed by using the silicon nitride film, etc. after the photo-lithography using microscope. Thus, it is possible to control the width more exactly.

A method of manufacturing the SSC integrated photodetector of the mentioned ridge shape will be below described in detail with reference to FIG. 3 and FIG. 8 to FIG. 14.

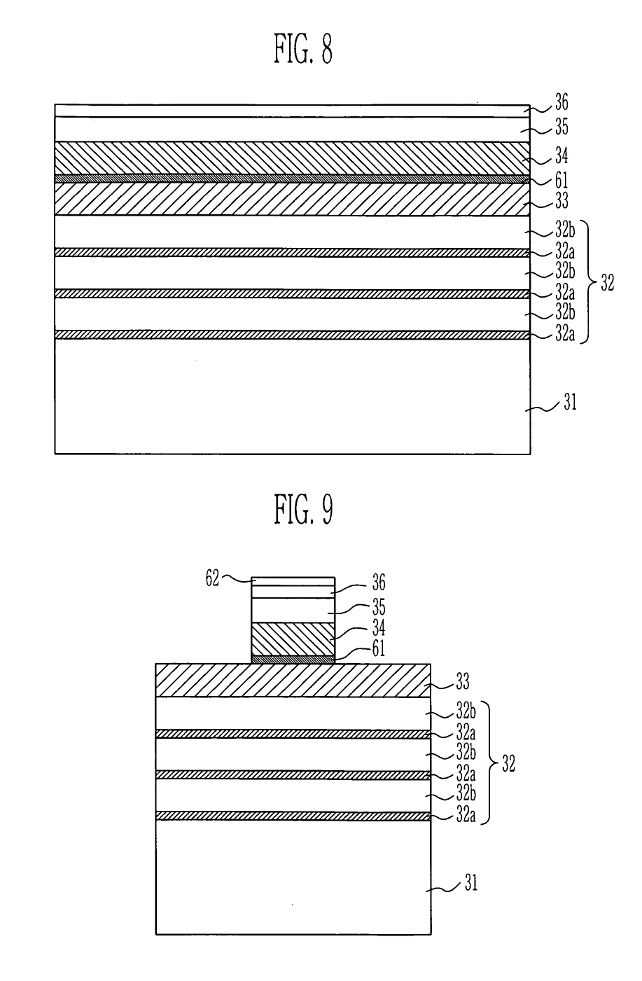

Referring to FIG. 8, multi-layers 32a and 32b having the three InP layers 32a of about 600 nm in thickness and the three InGaAsP (λg=1.24 μm) layers 32b of about 50 nm in thickness are stacked alternately repeatedly on the InP substrate 31. These layers constitute the first waveguide 32 for the optical coupling with the optical fiber, as in the above. And then, the InGaAsP (λg=1.24 μm) layer having a thickness in the range of 500 nm to 600 nm is formed on the first waveguide 32. It is preferred that the InGaAsP layer 33 is doped with the N type dopant since it serves to convert the size of the spot adiabatically and also is used as a N contact layer.

After the two waveguides 32 and 33 are formed, the InGaAs absorption layer 34, the P type InP cladding layer 35 and the P+ InGaAs contact layer 36 are grown. At this time, an InP etch-stop layer 61 having a thickness of 10 nm is grown between the second waveguide 33 and the InGaAs absorption layer 34 for a selective wet etch process.

By reference to FIG. 9, after a silicon nitride film 62 is deposited on the entire upper surface, a waveguide pattern for defining the absorption region in FIG. 3 is formed. Dry etch and wet etch are then performed using this waveguide pattern to form a ridge shape having a width in the range of 3 μm to 4 μm and a depth of 1 μm. Representative solutions for the selective wet etch process may include phosphoric acid or sulfuric acid based solution. Meanwhile, the SSC region of FIG. 3 has a state in which the InGaAs absorption layer 34, the P type InP cladding layer 35 and the P+InGaAs contact layer 36 are all etched (see FIG. 3).

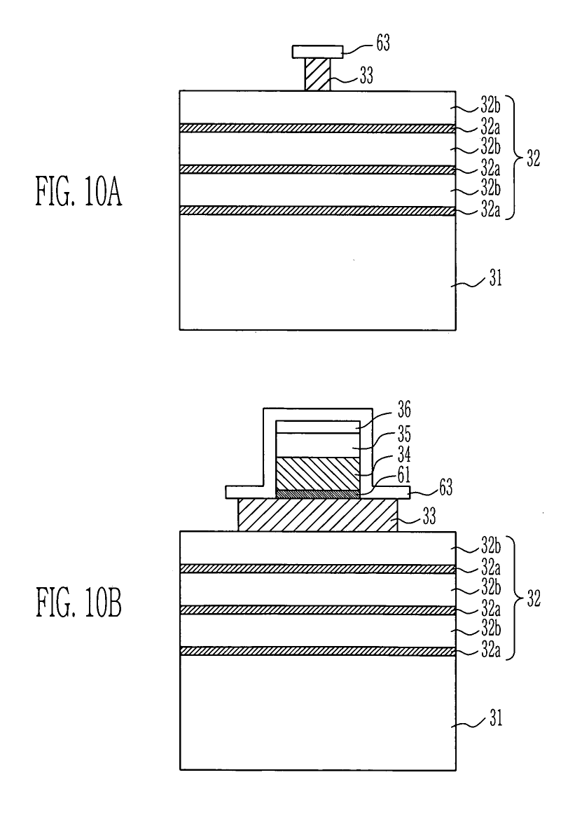

Next, referring to FIG. 10A and FIG. 10B, after the silicon nitride film 62 is removed, a silicon nitride film 63 is deposited again. The first waveguide 32 of the SSC region in FIG. 3 is defined (see FIG. 10A) and the N contact layer in the absorption region in FIG. 3 is patterned (see FIG. 10B). After dry etch of a given depth is performed, a thickness is controlled exactly through the selective wet etch process, as intended. At the same time, the width of the start portion is fabricated below 1 μm by means of the undercut etch process. At this time, phosphoric acid or sulfuric acid based solution may be used for the selective wet etch process.

This will be described in more detail. This process includes forming an exact depth and a width of below 1 μm through the undercut etch process using the selective wet etch method after the dry etch process. This structure has an advantage that the waveguide pattern requiring fine control of below 1 μm can be easily formed by using the pattern having a width in the range of 1.5 μm to 2 μm formed in the silicon nitride film and undercut. After the pattern having the width in the range of 1.5 μm to 2 μm is formed by the photo-lithography, the normal structure is first formed by the dry etch process and the following selective wet etch process is performed, as described above. Accordingly, it is possible to simplify the manufacturing process and secure the accuracy and the reproducibility in the process.

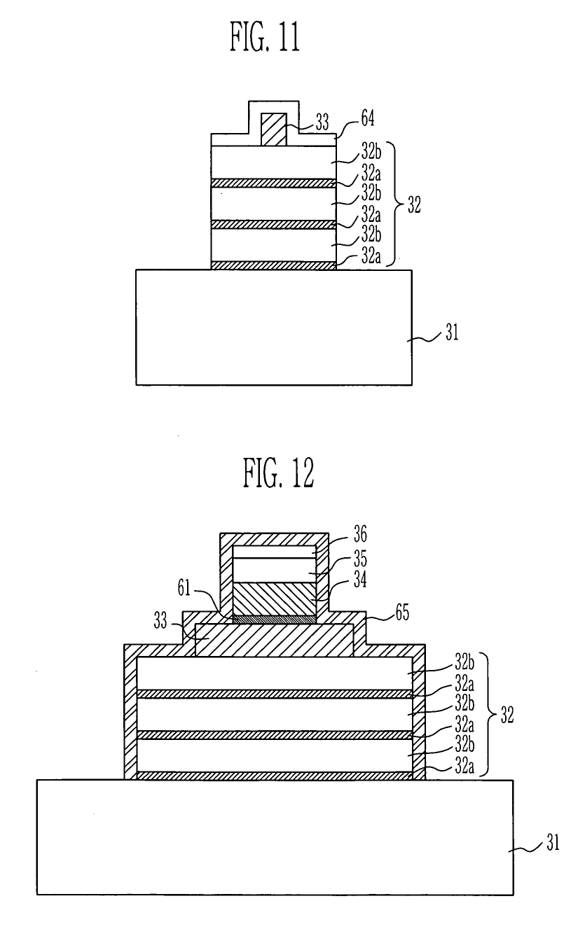

Referring to FIG. 11, after the silicon nitride film 63 is removed, the silicon nitride film 64 is deposited. And then, the pattern for the first waveguide 32 is formed. Next, the multi-layers 32a and 32b are formed to have a ridge shape in the range of 3 μm to 9 μm in width and ˜3 μm in depth, by means of a dry etch process using the pattern. At this time, the etch depth has a high tolerance, since it does not significantly affect the spot shape confined to the first waveguide 32 and has a certain depth that the electrode is not disconnected in a subsequent process for forming the electrode.

Referring to FIG. 12, after the silicon nitride film 64 is removed, the absorption layer region exposed in the air is passivated by using a polyimide 65. At this time, the polyimide 65 is formed to surround the first waveguide 32 in order to prevent disconnection of the electrode in the etch surface later.

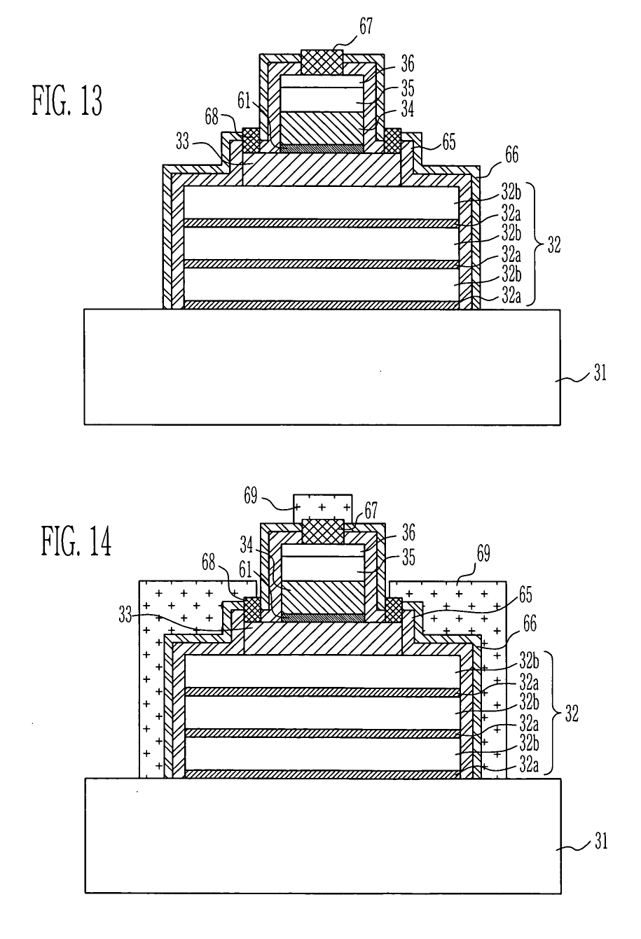

Next, referring to FIG. 13, a silicon nitride film 66 is deposited on the polyimide 65 in order to prevent degradation in the performance through the moisture absorption of the polyimide 65. A P type electrode 67 and an N type electrode 68 are then deposited.

Finally, referring to FIG. 14, the ridge-shaped SSC integrated photodetector is fabricated by depositing a coplanar type electrode 69 of ground-signal-ground.

On the other hand, as an alternative example, a structure that the second waveguide 33 is divided into a doped portion and an undoped portion in the epitaxial structure, whereby the N contact layer and the region capable of converting the spot size become to exist, is possible. This structure has effects that it can reduce a scattering loss due to free electrons since light does not travel along the N doped region, but it can reduce evanescent coupling efficiency. As this method is also based on the basic structure of the present invention, it is construed that this method is included in the technical sprit of the present invention.

As described above, the conventional problems can be easily resolved by the present invention using the selective wet etch method, and the SSC and the SSC integrated photodetector having the epitaxial structure suitable for it. Therefore, the present invention has new effects that it can readily couple with the optical fiber and the photodetector, reduce the cost for a optical alignment and significantly improve the optical coupling efficiency and quantum efficiency.

The forgoing embodiments are merely exemplary and are not to be construed as limiting the present invention. The present teachings can be readily applied to other types of apparatuses. The description of the present invention is intended to be illustrative, and not to limit the scope of the claims. Many alternatives, modifications, and variations will be apparent to those skilled in the art.

What is claimed is:

1. A spot size converter, comprising:
a semiconductor substrate;
a first waveguide stacked on the semiconductor substrate in a ridge shape and provided for optical coupling with an optical fiber; and
a second waveguide formed on the first waveguide for a spot size conversion, wherein the second waveguide has a taper shape having a width that is gradually widened in a direction along the waveguide at a start portion, and the start portion of the second waveguide has a mesa structure or a reverse-mesa structure.

2. The spot size converter as claimed in claim 1, wherein the mesa structure or the reverse-mesa structure has a width of below 1 μm (middle portion in thickness).

3. The spot size converter as claimed in claim 1, wherein the first waveguide consists of a multi-layer having structure that three InP layers of 600 nm in thickness and three InGaAsP (λg=1.24 μm) layers of 50 nm in thickness are stacked alternately and repeatedly.

4. The spot size converter as claimed in claim 1, wherein the second waveguide has an InGaAsP (lg=1.24 μm) layer in the range of 500 nm to 600 nm in thickness.

5. A method of manufacturing a spot size converter, wherein the spot size converter includes a semiconductor substrate; a first waveguide stacked on the semiconductor substrate in a ridge shape and provided for optical coupling with an optical fiber; and a second waveguide formed on the first waveguide for a spot size conversion, wherein the second waveguide has a taper shape having a width that is gradually widened in a direction along the waveguide at a start portion, characterized in comprising the steps of:
forming an etch mask on the second waveguide to remain the taper shape;
performing a dry etch of a given depth for the second waveguide using the etch mask; and
forming the start portion of the second waveguide dry etched, to have a mesa structure or a reverse-mesa structure by using an undercut wet etch process.

6. The method as claimed in claim 5, wherein the etch mask has a width in the range of 1.5 to 2 μm and is formed by photolithography.

7. The method as claimed in claim 5, wherein the mesa structure or the reverse-mesa structure has a width of below 1 μm (middle portion in thickness).

8. The method as claimed in claim 5, wherein the second waveguide has an InGaAsP (lg=1.24 μm) layer in the range of 500 nm to 600 nm in thickness; the dry etch process etches the second waveguide in thickness in the range of 200 nm to 400 nm; and the undercut wet etch process is implemented by using a phosphoric acid based etch solution.

9. The method as claimed in claim 5, wherein the mesa structure or the reverse-mesa structure has a azimuthal angle in the range of 30° to 60°.

10. A spot size converter integrated photodetector, comprising:
a semiconductor substrate;
a first waveguide for optical coupling with an optical fiber that is stacked on the semiconductor substrate and divided into a photodetection region and a spot size converter region, wherein the first waveguide is patterned in the spot size converter region in a ridge shape;
a second waveguide for converting the spot size; wherein the second waveguide has a taper shape having a width that is gradually widened in a direction along the waveguide from a start portion on the first waveguide of the spot size converter, start portion of said second waveguide of the spot size converter has a mesa structure or a reverse-mesa structure, and said second waveguide is extended to the first waveguide of the spot size converter on the photodetection region; and
an absorption layer, a cladding layer and an electrode layer, which are consecutively formed on the second waveguide of the photodetection region.

11. The spot size converter integrated photodetector as claimed in claim 10, wherein the mesa structure or the reverse-mesa structure has a width of below 1 μm (middle portion in thickness).

12. The spot size converter integrated photodetector as claimed in claim 10, wherein the first waveguide consists of a multi-layer having structure that three InP layers of 600 nm in thickness and three InGaAsP (λg=1.24 μm) layers of 50 nm in thickness are stacked alternately and repeatedly.

13. The spot size converter integrated photodetector as claimed in claim 10, wherein the second waveguide has an InGaAsP (lg=1.24 μm) layer in the range of 500 nm to 600 nm in thickness.
